(19) United States
(12) Patent Application Publication
(10) Pub. No.: US 2026/0029508 A1
(43) Pub. Date: Jan. 29, 2026

(54) RADAR SYSTEM

(71) Applicant: Carl Freudenberg KG, Weinheim (DE)

(72) Inventors: Tim LANGNER, Duisburg (DE); Florian RIEGER, Hirschberg (DE); Matthias HAUER, Weinheim (DE); Maximilian SCHÄFFNER, Griesheim (DE); Sascha MÖLLER, Bürstadt (DE); Christoph L. KLINGSHIRN, Eppelheim (DE); Stanislaus SCHMIDT, Mannheim (DE); Marc KNAPP, Mörlenbach (DE); Dirk MÖHRING, Mörlenbach (DE); Michael SARLEA, Hemsbach (DE); Birgit MÖBIUS, Weiterstadt (DE); Ulla PRESSLER, Hemsbach (DE)

(21) Appl. No.: 18/997,848

(22) PCT Filed: Jul. 17, 2023
(86) PCT No.: PCT/EP2023/069807

§ 371 Date: Jan. 23, 2025

(30) Foreign Application Priority Data
Jul. 25, 2022 (DE) 10 2022 118 583.4

(51) Int. Cl. G01S 7/03; H01Q 1/02; H01Q 1/32; H01Q 1/40

(52) U.S. Cl. CPC G01S 7/03; H01Q 1/02; H01Q 1/3233; H01Q 1/405

(57) ABSTRACT

A radar system, including an electronic component for transmitting and/or receiving radar signals. The radar system also includes an antenna element the antenna element being configured as a plastic body into which channels with metallized channel walls are introduced, the channels forming waveguides. Heat conducting elements are introduced into the antenna element.

### CROSS REFERENCE TO RELATED APPLICATIONS

This application is a U.S. National Phase application under 35 U.S.C. § 371 of International Application No. PCT/EP2023/069807, filed on Jul. 17, 2023, and claims benefit to German Patent Application No. DE 10 2022 118 583.4, filed on Jul. 25, 2022. The International Application was published in German on Feb. 1, 2024 as WO/2024/022872 A1 under PCT Article 21(2).

### FIELD

The invention relates to a radar system.

### BACKGROUND

A radar system is known from US 2021/0183797 A1, for example. Radar systems of the type mentioned above are often used in motor vehicles and form a component of driver assistance systems. For this purpose, radar systems record the environment and, based on the data recorded, make possible an automatic reaction by a motor vehicle or at least information to be provided to the driver, in particular in the form of a warning. Firstly, this makes it possible to regulate the speed of a vehicle to a speed specified by the driver if the traffic situation allows it, with the speed being automatically adjusted to the traffic situation. In emergency situations detected by the radar system, for example caused by other vehicles changing lanes unexpectedly, automatic emergency braking can be initiated. In driver assistance systems and autonomous driving systems, radar systems are often combined with other sensors, such as wheel sensors and camera sensors. In comparison to other systems, radar systems have the advantage that they are reliable even in poor weather conditions. In addition to measuring distances to detected vehicles and objects, it is also possible to determine the relative speed to other vehicles by using the Doppler effect.

With a radar system, the antenna element is a central element that significantly influences the functionality of the radar system. It is known to form the antenna element from a single-part or multi-part plastic body, with channels being introduced into the antenna element and the channel walls being electrically conductive, the channels forming waveguides. The antenna element is brought into operative connection with the electronic component for transmitting and/or receiving radar signals.

The electronic component is usually a microchip in the form of a high-frequency chip that is arranged on a circuit board. It is problematic that a significant amount of heat is emitted during operation of the radar system, which is due in particular to the need to provide electromagnetic waves in a spectrum that is typical for radar waves with sufficient range. Depending on the design of the radar system, the heat emission can amount to several watts, which is associated with a high heat load in a small space, in particular with compact radar systems. Due to their low thermal conductivity, antenna elements made of plastic are only partially suitable for dissipating heat from the system in an appropriate manner.

Summary A radar system, comprising an electronic component for transmitting and/or receiving radar signals. The radar system also comprises an antenna element the antenna element being configured as a plastic body into which channels with metallized channel walls are introduced, the channels forming waveguides. Heat conducting elements are introduced into the antenna element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a view of a radar system in section according to an embodiment of the present disclosure;

FIG. 2 shows a view of an antenna element in a spatial view obliquely from above;

FIG. 3 shows a view of an antenna element in a spatial view obliquely from below;

FIG. 4 shows a view of an antenna element in plan view; and

FIG. 5 shows a diagram illustrating thermal conductivity depending on a number of heat conducting elements.

### DETAILED DESCRIPTION

In an embodiment, the present disclosure provides a radar system having improved thermal properties.

The radar system according to an embodiment comprises an electronic component for transmitting and/or receiving radar signals and an antenna element, the antenna element being designed as a plastic body into which channels with electrically conductive channel walls are introduced, the channels forming waveguides, heat conducting elements being introduced into the antenna element.

According to an embodiment, the antenna element has thermal properties in addition to electromagnetic properties and can transport heat through the antenna element, but also out of the antenna element. For example, the antenna element can transport heat introduced during manufacture via the heat conducting elements. This can provide an increase the heat supply during manufacture and also to shorten cooling time. Furthermore, this can provide a compact radar system that is robust and can be operated over a long period of time. Due to the improved thermal properties of the antenna element, the temperature within the antenna element becomes more uniform. In addition, the heat dissipation of the chips that transmit and receive the radar radiation is also improved, so that the measurement accuracy of the radar system and the transmission power are improved.

In the case of multi-part antenna elements, the individual elements are often connected to one another by means of a soldering method. The heat is usually supplied via an air stream that is applied to both sides of the antenna element. The heat conducting elements improve the transport of warm air and heat can be transported more effectively into the interior of the elements. This allows the joining process to be accelerated and at the same time results in improved quality of the soldered connection.

The heat conducting elements can comprise recesses and/or openings introduced into the plastic body. The recesses and/or openings are introduced into the plastic body independently of the channels forming the waveguides. Temperature-resistant polymers such as polyphenylene sulfide (PPS), polyetherimide (PEI), polyphenylene ether (PPE), polyamide (PA), liquid crystalline polymer (LCP), polycarbonate (PC), polyphthalamide (PPA), polyetheretherketone (PEEK) or mixtures of the aforementioned polymers are particularly suitable as plastics for the antenna element.

Preferably, the regions of the antenna element are free of recesses and/or openings associated with the microchip or the corresponding region of the circuit board.

Thermal conductivity can be improved by coating the recesses and/or openings with thermally conductive material. Advantageous materials for the coating include metals such as nickel, chromium, aluminum, copper, tin, zinc, silver or gold. These materials are also suitable for electrically conductive equipment of the channel walls. The metallic coating can be single-layer or multi-layer. The coating of the recesses and/or openings allows heat to be conducted parallel to the material of the antenna element, so that overall thermal conductivity is improved. A typical thermal conductivity coefficient for plastic is, for example, approximately 0.3 W/m×K and for copper approximately 300 W/m×K.

A metallic coating can be applied in particular by galvanic coating.

Ceramic coatings, for example based on aluminum oxide, can also be applied. Ceramic coatings can be applied using a vacuum process.

The layer thickness of the coating is preferably between 0.5 μm and 40 μm. Such a coating is cost-effective and has good thermal conductivity.

The recesses can be designed in the form of blind holes or through holes, for example. The recesses can be designed in a circular shape. However, preferably, the recesses or openings have a non-circular shape. An advantage here is that the surface area of the recesses or openings is increased, which in turn increases thermal conductivity. This applies in particular if the walls of the recesses and/or openings are coated with thermally conductive material. For example, the recesses or openings can be cloverleaf-shaped when viewed from above. In order to improve cooling performance, the recesses and/or openings preferably do not accommodate any objects, in particular no retaining means such as screws and the like.

The recesses and/or openings can form channels. The recesses protrude into the plastic body or, in the case of openings, penetrate the plastic body. This this can provide the dissipation of heat from the radar system through the plastic body or to transfer it to other components of the radar system via the plastic body.

The heat flow through the antenna element increases with the number of recesses and/or openings per unit of area. Preferably, the unit of area refers to the surface of the antenna element that faces the electronic component. It has proven to be advantageous if between 10 and 50 recesses and/or openings are provided per cm² of surface facing the electronic component. A good heat flow is achieved with as few as 3 recesses and/or openings per cm². The recesses and openings can have a wide variety of geometric shapes, with the geometric shape and in particular the surface available for heat transfer influencing the heat transfer. In particular, the recesses can be arranged in the region of the surface facing the electronic component. The openings are preferably designed such that they penetrate the antenna element.

Depending on the design of the recesses and/or openings, it can be sufficient if between 3 and 15 recesses or openings are provided per cm² of surface facing the electronic component, if the recesses or openings are elongated and in particular have a length of more than 10 mm. In the case of meandering structures, 1 to 10 per cm² of surface facing the electronic component can be sufficient. Meandering structures are particularly advantageous for recesses close to the surface. Overall, this embodiment provides good thermal conductivity through the antenna element, particularly during production and the associated joining processes. At the same time, the functionality of the antenna element is not impaired.

The heat conducting elements can comprise recesses in the form of surface structures. For example, surface structures in the form of ribs or grooves can be introduced into the surface of the plastic body, the surface structures increasing the surface area of the plastic body, which in turn is accompanied by an increase in thermal conductivity. The surface structure can be introduced in the regions of the plastic body that are not related to the channels forming the waveguides. Advantageous heat dissipation via the surface structures results if 3 to 15 structures in the form of ribs or grooves are provided per cm² of surface facing the electronic component. This applies in particular if the structures are elongated and have a length of more than 10 mm. In the case of meandering structures, 1 to 10 recesses per cm² of surface facing the electronic component can be sufficient.

Heat conducting bodies can be embedded in the antenna element. Heat conducting bodies have a higher thermal conductivity coefficient than the material of the plastic body. This allows heat to be transported to the outside particularly quickly and effectively via the heat conducting bodies.

The heat conducting bodies can be made of metallic material. In this connection, the heat conducting bodies can be designed as molded parts, for example in the form of cylindrical elements such as sleeves or wires. The heat conducting bodies can be designed in the form of metal sheets. Thermally conductive materials made of metallic materials such as copper or aluminum are particularly suitable as materials for the heat conducting bodies.

The heat conducting bodies can be made of thermally conductive plastic. The heat conducting bodies are designed such that their thermal conductivity is greater than that of the material of the plastic body. In this connection, the heat conducting bodies can be in the form of flexible conductor tracks or pre-molded parts. Although these have a lower thermal conductivity compared to heat conducting bodies made of metallic materials, it is advantageous that heat conducting bodies made of plastics can be realized in complex geometries. This is advantageous in connection with complex waveguide structures. Preferably, the thermally conductive plastic has a thermal conductivity of at least 1 W/m×K.

The antenna element can be designed in multiple layers. Such embodiments can form particularly complex channels and/or to arrange heat conducting elements within the plastic body. Furthermore, the layers of the multi-layer antenna element can have different thermal conductivity properties. In this connection, it is particularly advantageous if the layer facing the component or the circuit board has a higher thermal conductivity than the other layers. For this purpose, the layer facing the component or the circuit board can be provided with a thicker coating, in particular with a thicker metallic coating.

The heat conducting elements can comprise applied, for example printed, structures. For example, a thermally conductive material can be printed or glued onto the outside of the plastic body.

The antenna element can be covered by a radome. The radome protects the antenna element from external influences. The radome can form a structural unit with the antenna element. With this embodiment, the waveguides are closed on the side where the electromagnetic radiation exits and the electromagnetic radiation is passed through by a corresponding modification of the coating.

The figures show a radar system 1, which is part of a driver assistance system of a vehicle. The radar system 1 comprises an electronic component 2 for transmitting and/or receiving radar signals and an antenna element 3, which is arranged on the electronic component 2. The component 2 is designed in the form of an integrated circuit and is arranged on a circuit board 6. The antenna element 3 is materially connected to the component 2 via an adhesive bond.

In an embodiment, the electronic component 2 is arranged on one main side of the circuit board 6 and the antenna element 3 on the other main side. The circuit board 6 is designed to allow electromagnetic radiation to pass between the component 2 and the antenna element 3.

The antenna element 3 is designed as a plastic body made of polyetheretherketone (PEEK), the plastic body that forms the antenna element 3 being multi-layered and formed from a plurality of plates stacked one on top of the other. A plurality of channels 4 with metallized channel walls are introduced into the plastic body, the channels 4 forming waveguides. The waveguides are in operative connection with the transmitting/receiving units of the electronic component 2. The antenna element is covered by a radome.

Heat conducting elements 5 are introduced into the antenna element 3, which in the present embodiment comprise recesses and openings. The recesses and openings form channels. The recesses on the side facing the component 2 are designed such that surface structures are formed there. Heat conducting bodies made of metallic material, in this case aluminum, are embedded in the recesses. In an embodiment, the heat conducting bodies are made of thermally conductive plastic. In an embodiment, the heat conducting elements 5 comprise printed structures.

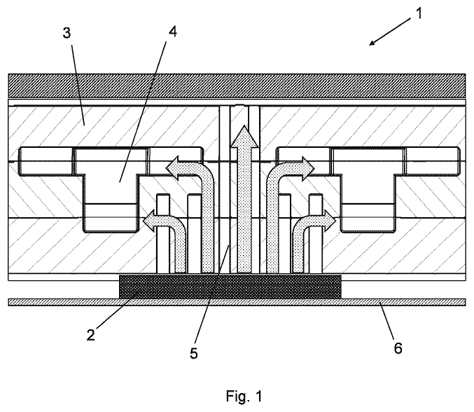

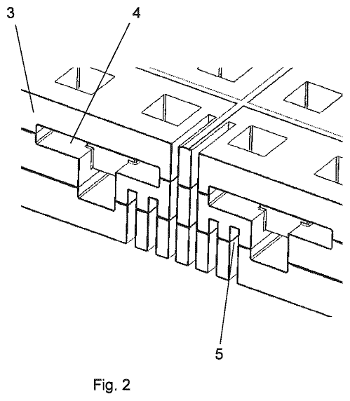

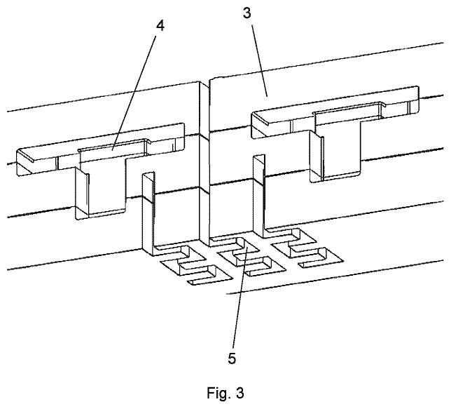

FIG. 1 shows the previously described radar system 1 in section. FIG. 2 shows an antenna element 3 in a spatial view obliquely from above and FIG. 3 shows an antenna element 3 in a spatial view obliquely from below with heat conducting elements 5 in the form of meandering openings and recesses. The walls of the recesses and openings are coated with a thermally conductive material.

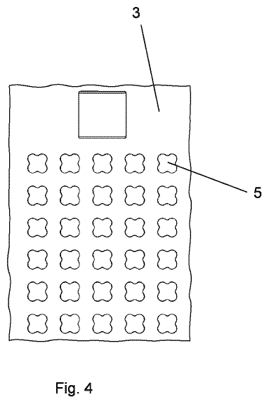

FIG. 4 is a plan view of an embodiment of an antenna element 3, with which the heat conducting elements 5 are designed in the form of openings which penetrate the antenna element 3. The cross-sectional shape of the openings with this embodiment is cloverleaf-shaped. With this embodiment, the channel walls have a larger surface area in relation to the cross-sectional area of the recess, which represents the space required for an opening, and thus thermal conductivity is improved.

The channel walls are provided with a coating of metallic material, in this case aluminum. The layer thickness of the coating is 20 μm. In the present embodiment, 24 recesses are introduced in the antenna element per cm² of surface facing the electronic component 2.

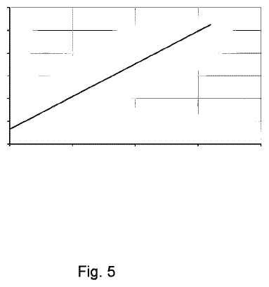

FIG. 5 shows a diagram of a simulation calculation, from which it can be seen that the heat flow increases with the number of openings. The abscissa represents the number of openings from 0 to 12 and the ordinate represents the heat flow at 40 Kelvin from 0 watts to 3 watts. The calculation is based on the fact that elongated openings with a length of 23 mm and a width of 1.2 mm are introduced in a cube comprising polyamide with an edge length of 25 mm. The surface of the cube is coated with gold with a layer thickness of 10 μm. A temperature difference is created in the direction of the openings, which causes a heat flow in the same direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radar system, comprising:
an electronic component for transmitting and/or receiving radar signals; and
an antenna element, the antenna element being configured as a plastic body into which channels with metallized channel walls are introduced, the channels forming waveguides,
wherein heat conducting elements are introduced into the antenna element.

2. The radar system according to claim 1, wherein the heat conducting elements comprise recesses and/or openings.

3. The radar system according to claim 2, wherein the recesses and/or openings form channels.

4. The radar system according to either claim 2, wherein the recesses and/or openings have a thermally conductive coating.

5. The radar system according to claim 2, wherein between 3 and 15 recesses and/or openings are provided per-square centimeter of a surface facing the electronic component.

6. The radar system according to claim 4, wherein the coating comprises a metallic material.

7. The radar system according to claim 4, wherein a layer thickness of the coating is between 0.5 μm and 40 μm.

8. The radar system according to claim 4, wherein the coating is configured as a galvanic coating.

9. The radar system according to claim 1, wherein the heat conducting elements comprise surface structures.

10. The radar system according to claim 1, wherein the heat conducting elements comprise heat conducting bodies embedded in the antenna element.

11. The radar system according to claim 10, wherein the heat conducting bodies are made of metallic material.

12. The radar system according to claim 10, wherein the heat conducting bodies are made of thermally conductive plastic.

13. The radar system according to 1, wherein the antenna element is configured in multiple layers.

14. The radar system according to claim 13, wherein a layer assigned to the electronic component has a higher thermal conductivity than other layers.

15. The radar system according to claim 1, wherein the heat conducting elements comprise printed structures.
